(19) United States
(12) Patent Application Publication
(10) Pub. No.: US 2026/0208098 A1
(43) Pub. Date: Jul. 23, 2026

(54) ADVANCED MEMBRANE OXIDATION PROCESS AND SYSTEM FOR THE TREATMENT OF INDUSTRIAL GAS EMISSIONS AND ODORS

(71) Applicants: Abdelmajid RAKIB, Sainte-Catherine (CA); ALFAPUR TECHNOLOGIES (9419-8488 Québec Inc.), Sainte-Catherine (CA)

(72) Inventor: Abdelmajid RAKIB, Sainte-Catherine (CA)

(21) Appl. No.: 19/452,593

(22) Filed: Jan. 19, 2026

Related U.S. Application Data
(60) Provisional application No. 63/748,078, filed on Jan. 22, 2025.

(51) Int. Cl. B01D 53/22; B01D 53/00; B01D 53/14; B01D 53/76

(52) U.S. Cl. CPC B01D 53/229; B01D 53/007; B01D 53/14; B01D 53/228; B01D 53/76; B01D 2251/104; B01D 2251/106; B01D 2252/10; B01D 2257/302; B01D 2257/304; B01D 2257/404; B01D 2257/708; B01D 2259/804

(57) ABSTRACT

The re provided a process for treating a gaseous material. The process comprises contacting the gaseous material with an oxidizing porous ceramic membrane placed within a reactor. An oxidizing agent associated with the membrane is formed upon reaction between a membrane material and ozone (O₃) that is fed into the reactor. The oxidizing porous ceramic membrane may be subjected to an electromagnetic radiation during the process. A liquid comprising a sorbent material, such as a liquid nano-sorbent, may flow through the membrane during the process, and formation of the oxidizing agent further involves the sorbent material. Also, there is provided a system associated with the process as well as a method for the preparation of a liquid nano-sorbent material.

### CROSS REFERENCE TO RELATED APPLICATIONS

This application claims benefit of U.S. Provisional Ser. No. 63/748,078 filed on Jan. 22, 2025. The content of this application is incorporated herein in its entirety by reference.

### FIELD OF THE INVENTION

The invention relates generally to processes for the treatment of gaseous materials. More specifically, the invention relates to an advanced membrane oxidation process (AMOP) and associated system for the treatment of industrial gas emissions and odors. The process according to the invention involves use of an oxidizing porous ceramic membrane. Also, the process may involve use of an electromagnetic radiation.

### BACKGROUND OF THE INVENTION

Industrial gas emissions and odors management remains a pressing environmental challenge, particularly in industries such as chemicals, petrochemicals, smelters, refineries, cement plants, and incinerators. These sectors are significant contributors to air pollution, emitting toxic substances and greenhouse gases that degrade air quality, pose severe health risks, and lead to substantial financial penalties for non-compliance with environmental regulations.

Indeed, industrial processes such as combustion, chemical transformations, and material production release a wide spectrum of pollutants, including: carbon dioxide (CO₂); methane (CH4); carbon monoxide (CO); volatile organic compounds (VOCs); propylene oxide; acetone; benzene, toluene, and xylenes (BTX); sulfur dioxide (SO₂), hydrogen sulfide (H₂S), ammonia (NH₃), nitric oxide (NO), nitrogen dioxide (NO₂); carbonyl compounds (e.g., formaldehyde, acetaldehyde). Industrial processes also release fine particles.

The odors generated during sludge storage mainly result from the anaerobic decomposition of organic matter. This process produces a variety of volatile compounds and toxic emissions such as (H₂S, SO₂, NH₃, NO, NO₂, etc.) that are highly odorous and toxic, even at low concentrations (ppb).

These industrial gas emissions not only contribute to global warming but also pose serious health hazards. Prolonged exposure to these pollutants can cause respiratory diseases, cancer, and other health issues.

Current methods for treating these emissions present notable limitations. For example, existing technologies frequently fail to efficiently capture a wide spectrum of contaminants, allowing harmful compounds to remain in the atmosphere. Also, many traditional methods, such as activated carbon filters, are single-use and require frequent replacement, leading to high operational costs. Moreover, technologies such as thermal oxidation consume significant amounts of energy, increasing both operational costs and environmental impacts.

Typically, current methods known in the art for treating industrial gas emissions include filters, scrubbers, and thermal oxidizers. However, these approaches face significant challenges such as limited pollutant range. Indeed, many systems are designed to target specific pollutants, leaving other harmful substances untreated. Also, filters and scrubbers often require regular replacement, which leads to high maintenance costs and generation of additional waste. Moreover, some of these methods, such as thermal oxidation for example, require substantial energy inputs, reducing their overall environmental efficiency.

As indicated herein above, processes for treating industrial emissions and odors are know in the art. For example, US 2023/0133019A1 describes a two-step regenerative thermal oxidation process for burning volatile organic compounds for small facilities. EP 0719984A3 describes the improved regenerative thermal oxidation process for purifying polluted waste gases from an industrial process.

Regenerative thermal oxidation, while effective at destroying volatile organic compounds, has notable limitations. Its initial costs are high, and maintenance of materials is frequent due to wear and tear. At low VOC concentrations, regenerative thermal oxidation becomes energy-intensive and loses efficiency. It operates at relatively high temperatures, which can lead to corrosion hazards and the formation of harmful by-products such as NOₓ. In addition, the process generates CO₂, requires a lot of space, and poses challenges in the face of specific contaminants such as halogens or sulphur.

WO 2018/091379 describes a process for treating VOCs by recuperative pathways (absorption, adsorption, and condensation). Absorption is the scrubbing of gas by a solvent in which pollutants are transferred from the gas phase to the liquid phase. For obvious reasons, the affinity of the pollutant with the absorbent liquid phase is therefore decisive. Efficiency and investment and operating costs are thus governed by a polluting/absorbing compromise. In addition, current absorption washing methods are generally restricted to water-soluble VOCs as they mainly use water or aqueous solutions using chemical bases, acids, or reagents. For the treatment of hydrophobic organic compounds (e.g., aromatic and aliphatic hydrocarbons), washing systems using heavy solvents, such as silicone oils, polyethylene glycol, or adipates, have been experimented with (Heymes et al., Chem. Eng. J., 2006, 115(3), 225-231). However, their cost of use remains high and some of these compounds are not without toxicity.

Other studies have been conducted using ionic liquids (ILs) as washing solvents (Quijano et al., Chem. Eng. Sc., 2011, 66(12), 2707-2712, and Gonzalez-Miquel et al., J. Phys. Chem. B, 2013, 117(1), 296-306). However, although ILs have a very good absorption capacity against VOCs, they have, in addition to a certain toxicity, disadvantages related to their synthesis (purification steps required). For example, ILs with BF₄ or PF₆ counterions are not stable and can release toxic by-products such as HF and POF₃ in the presence of moisture, preventing application of these compounds (Freire et al., J. Phys. Chem. A 2010, 114, 3744-3749 and Swatloski et al., Green Chemistry, 2003, 5, 361-363).

WO 00/72945 describes a process for treating VOCs using photocatalysis. However, major limitations of photocatalysis lie in the fact that, on the one hand, the photon yield of this reaction is relatively low and that, on the other hand, some compounds, in particular fluorinated ones, cannot be decomposed by this reaction. The prior art mainly mentions the use of photocatalysis for liquid processing, with catalysts such as TiO₂ or MnO₂, activated by wavelengths of about 380 nm. However, this approach remains limited in terms of effectiveness.

WO 2004/002902 describes a process for the oxidation of organic compounds involving their contact with a composition comprising a soluble peroxygen compound and a divalent or trivalent transition metal source, combined with a chelating agent. This oxidation method is particularly effective in liquid media, such as in wastewater treatment. However, it has limitations due to the instability of the free radicals formed, which have a very short lifespan. Outside the liquid medium, the application of this technique becomes complex. The present invention is inspired by peroxygen-based oxidation but adapts it in an innovative way for the gaseous medium.

On the other hand, the prior art for the treatment of acid gas streams focuses mainly on the use of conventional methods, such as wet scrubbing or spray-dry scrubbing, using a lime sorbent. Indeed, lime neutralization treatments, whether dry or semi-wet, generate a large quantity of solid waste, composed for the most part of gypsum polluted by metals considered toxic, such as lead, cadmium, aluminum, arsenic, etc. These techniques, although functional for industries until now, remain virtually without viable alternatives, forcing manufacturers to use them despite their limitations in terms of efficiency and cost. In the absence of more advanced replacement methods, these conventional solutions remain unavoidable, despite the growing need for more efficient and sustainable innovations to meet today's environmental and economic requirements.

CA 2,565,750 describes a process using hydrogen peroxide as a washing solution for SOₓ, NOₓ, and heavy metal emissions, providing a particularly effective method. However, this technique has significant limitations. The prior production of hydrogen peroxide and its use as a washing solution require rigorous control. Challenges include the gradual decrease in peroxide concentration, the generation of effluents that need to be stored and treated, thus increasing costs and complexity. To overcome these limitations, an alternative approach is needed, allowing hydrogen peroxide to be produced in situ and used immediately, thus optimizing its oxidizing potential, which is the goal of this invention.

Given that most industrial chimneys release a complex mixture of pollutants, including volatile organic compounds, acidic gases, fine particles, and heavy metals. The simultaneous treatment of VOC and acid gas emissions is a major challenge for current abatement technologies. To date, most available solutions are designed to target just one category of pollutant, requiring separate systems to handle VOCs and acidic gases individually. This fragmentation leads to higher installation, operation and maintenance costs, which are complex and difficult to integrate into existing infrastructures. While today's technologies, such as wet gas scrubbers, adsorption filters, liquid absorbers, or selective thermal or catalytic oxidation, target certain types of gases, they have limitations. For example, scrubbers effectively capture acid gases such as sulfur dioxide but not volatile organic compounds, while catalytic reduction systems do reduce nitrogen oxides but not volatile organic compounds or sulfur dioxide. This specialisation has led to a dead end. Indeed, it is currently not possible to treat several pollutants efficiently and simultaneously in a single system without the use of complex and expensive equipment. New solutions need to be developed to overcome the limitations of existing technologies and purify our emissions holistically.

This lack of technological integration not only complicates the decontamination process but also creates major energy inefficiencies. Each system requires energy consumption that is specific to its operation, which increases the overall energy load and indirectly contributes to greenhouse gas emissions. In addition, these processes often require consumables (activated carbon, chemical reagents, liquid absorbents) and regular maintenance, further increasing costs and waste management.

The real technological challenge for manufacturers today is to design a system capable of treating multiple pollutants simultaneously, while remaining economically viable, environmentally friendly and adaptable to various industrial configurations. So far, no solution has been able to overcome this challenge in a fully satisfactory way, leaving a technological gap that the proposed advanced membrane oxidation of the present invention, seeks to fill.

There is a need for improved processes for treating industrial gas emissions and odors. In particular, there is a need for such processes that are efficient, cost-effective, and environmentally friendly.

### SUMMARY OF THE INVENTION

The inventor has designed and developed an advanced membrane oxidation process (AMOP) and associated system for the treatment of industrial gas emissions and odors. The process involves the use of an oxidizing porous ceramic membrane placed within a reactor. Also, the process may involve use of an electromagnetic radiation.

In embodiments of the invention, an ozone (O₃) distributor feeds O₃ into the reactor during the process. And reaction of O₃ with a membrane material leads to the formation of an oxidizing agent associated with the membrane.

In embodiments of the invention, a liquid comprising a sorbent material flows through the membrane, and formation of the oxidizing agent further involves the sorbent material. Such liquid may be a liquid nano-sorbent (LNS). In other embodiments, a fluid comprising hydrogen peroxide (H₂O₂) flows through the membrane, and formation of the oxidizing agent further involves H₂O₂.

In embodiments of the invention, the porous ceramic membrane is made of a material comprising selected from: alumina (Al₂O₃), magnesium oxide (MgO), calcium oxide (CaO), zirconium oxide (ZrO₂), titanium oxide (TiO₂), silicon carbide (SiC), and a combination thereof.

In embodiments of the invention, the oxidizing agent is selected from: hydrogen peroxide (H₂O₂), MgO₂, CaO₂, ozone (O₃), and a combination thereof.

In embodiments of the invention, the sorbent material is in nano form and comprises nanoparticles of magnesium hydroxide (Mg(OH)₂), nanoparticles of calcium hydroxide (Ca(OH)₂), nanoparticles of zinc hydroxide (Zn(OH)₂), nanoparticles of carbon/activated carbon/biochar, nanoparticles of dolomites (CaMg(CO₃)₂), nanoparticles of fly ashes, and a combination thereof.

In embodiments of the invention, electromagnetic radiation is an ultraviolet (UV) radiation selected from the group consisting of UVA, UVB, and UVC.

In embodiments of the invention, there is provided a system adapted for conducting the process for treating a gaseous material according to the invention.

In embodiments of the invention, there is provided a method for the preparation of a liquid nano-sorbent which may be used in the process according to the invention.

### THE INVENTION THUS PROVIDES THE FOLLOWING IN ACCORDANCE WITH ASPECTS THEREOF:

(1) A process for treating a gaseous material, comprising contacting the gaseous material with an oxidizing porous ceramic membrane placed within a reactor, wherein an oxidizing agent associated with the membrane is formed upon reaction between a membrane material and ozone (O₃) that is fed into the reactor; optionally the oxidizing porous ceramic membrane is subjected to an electromagnetic radiation during the process.
(2) The process according to (1) above, wherein a liquid comprising a sorbent material flows through the membrane during the process, and formation of the oxidizing agent further involves the sorbent material; preferably the sorbent material is in nano form; more preferably the liquid is a liquid nano-sorbent (LNS).
(3) The process according to (1) above, wherein a fluid comprising hydrogen peroxide (H₂O₂) flows through the membrane during the process, and formation of the oxidizing agent further involves H₂O₂.
(4) The process according to (2) above, wherein a fluid comprising hydrogen peroxide (H₂O₂) flows through the membrane during the process, and formation of the oxidizing agent further involves H₂O₂.
(5) The process according to (1) above, comprising contacting the gaseous material with the oxidizing porous ceramic membrane placed within a reactor, wherein a liquid comprising a sorbent material and a fluid comprising hydrogen peroxide (H₂O₂) each independently flows through the membrane, and wherein the oxidizing agent associated with the membrane is formed upon reaction between a membrane material, the sorbent material, H₂O₂, and ozone (O₃) that is fed into the reactor.
(6) The process according to (1) above, wherein the membrane material is selected from the group consisting of: alumina (Al₂O₃), magnesium oxide (MgO), calcium oxide (CaO), zirconium oxide (ZrO₂), titanium oxide (TiO₂), silicon carbide (SiC), and a combination thereof; preferably the membrane material is magnesium oxide (MgO).
(7) The process according to (1) above, wherein the oxidizing agent is selected from the group consisting of: hydrogen peroxide (H₂O₂), MgO₂, CaO₂, ozone (O₃), and a combination thereof.
(8) The process according to (1) above, wherein the sorbent material is selected from the group consisting of: magnesium oxide (MgO), calcium oxide (CaO), carbon/activated carbon/biochar, dolomites (CaMg(CO₃)₂), fly ashes, and a combination thereof;
preferably the sorbent material is selected from the group consisting of: nanoparticles of magnesium hydroxide (Mg(OH)₂), nanoparticles of calcium hydroxide (Ca(OH)₂), nanoparticles of carbon/activated carbon/biochar, nanoparticles of dolomites (CaMg(CO₃)₂), nanoparticles of fly ashes, and a combination thereof.
(9) The process according to (1) above, wherein the electromagnetic radiation is an ultraviolet (UV) radiation selected from the group consisting of UVA, UVB, and UVC.
(10) The process according to (1) above, wherein the membrane has a shape that is flat or tubular; preferably the membrane is flat.
(11) The process according to (1) above, wherein the membrane has a porosity which is adapted for allowing a liquid containing the oxidizing agent to diffuse throughout the membrane from an inside surface to an outer surface thereof.
(12) The process according to (1) above, wherein the membrane operates at a relatively low temperature and/or a relatively low pressure.
(13) The process according to (1) above, which is executed continuously and/or which is adapted for real-time monitoring and adjustments.
(14) The process according to (1) above, wherein the gaseous material is an industrial gas emission.
(15) The process according to (1) above, wherein the gaseous material comprises industrial toxic pollutants such as methane (CH₄), carbon monoxide (CO), carbon dioxide (CO₂) volatile organic compounds (VOCs), propylene oxide, acetone, benzene-toluene-xylenes (BTX), polycyclic aromatic hydrocarbons (PAHs), chlorofluorocarbons (CFCs), hydrofluorocarbons (HFCs), carbonyl compounds (formaldehyde, acetaldehyde), hydrogen sulfide (H₂S) and ammonia (NH₃), along with acidic emissions like sulfur dioxide (SO₂), nitrogen oxides (NOx), hydrogen chloride (HCl), hydrogen fluoride (HF), and fine particles.

(16) The process according to (1) above, wherein a content of the treated gaseous material is about 82% to about 99% reduced in volatile organic compounds (VOCs) and acidic gases such as sulfur oxides (SOₓ), nitrogen oxides (NOₓ), and hydrogen sulfide (H₂S).

(17) A system for treating a gaseous material, comprising: a reactor; at least one porous ceramic membrane placed into the reactor; and an ozone (O₃) distributor adapted to feeding O₃ into the reactor; optionally the system comprises a hydrogen peroxide (H₂O₂) distributor adapted to feeding H₂O₂ to the at least one membrane; optionally the system comprises a liquid sorbent material distributor adapted to feeding the liquid sorbent material to the at least one membrane; optionally the system comprises an ultraviolet (UV) radiation system adapted to submitting radiation to the at least one membrane; preferably the O₃ distributor comprises means for controlling an amount of O₃ fed into the reactor; preferably the O₃ distributor receives O₃ from an ozone (O₃) generator adapted to generate O₃ from oxygen; preferably the system is a closed-loop system; preferably the system is adapted for integration into existing industrial installations without requiring significant modifications to the infrastructure.

(18) A gas treatment plant comprising a plurality of systems as defined in (17) above; optionally the systems are mounted in a mode selected from; parallel mode, modular mode, compact mode, standalone mode, and a combination thereof.

(19) A method for preparing a liquid nano-sorbent, comprising: a first step based on a top-down approach and a second step based on a membrane nanofiltration technology; optionally, prior to conducting the first and second steps of the method, raw materials are subjected to ultrafine mechanical grinding followed by mechanical sieving to obtain sieved particles; optionally the first step of the method comprises forming a suspension comprising the sieved particles and a dispersing agent, and subjecting the suspension to mechanical grinding; optionally the second step of the method comprises subjecting the grinded suspension to a membrane nanofiltration wherein a permeate is recovered, and a retentate with larger size particles is removed or recycled; optionally the method further comprises subjecting the permeate to a nanofiltration process comprising use of a stabilizer.

(20) A liquid nano-sorbent obtained by the method as defined in (19) above; optionally an equivalent diameter of particles of the liquid nano-sorbent is less than 100 nm or is between about 20 to about 100 nm.

Other objects, advantages and features of the present invention will become more apparent upon reading the following non-restrictive description of specific embodiments thereof, given by way of example only with reference to the accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

In the appended drawings:

FIG. 1: Reaction mechanism involved in the advanced membrane oxidation process (AMOP) according to the invention.

FIG. 2: Schematic diagram of an embodiment of the AMOP.

FIG. 3: Evolution of CO₂, SO₂, H₂S, CH4, NH₃, and total volatile organic compounds (TVOC) concentrations as a function of time.

### DESCRIPTION OF ILLUSTRATIVE EMBODIMENTS

Before the present invention is further described, it is to be understood that the invention is not limited to the particular embodiments described below, as variations of these embodiments may be made and still fall within the scope of the appended claims. It is also to be understood that the terminology employed is for the purpose of describing particular embodiments; and is not intended to be limiting. Instead, the scope of the present invention will be established by the appended claims.

In order to provide a clear and consistent understanding of the terms used in the present specification, a number of definitions are provided below. Moreover, unless defined otherwise, all technical and scientific terms as used herein have the same meaning as commonly understood to one of ordinary skill in the art to which this disclosure pertains.

Use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

According to an aspect, a primary problem addressed by the present invention is the efficient capture and disposal of toxic substances, including volatile organic compounds (VOCs), acid gases, fine particles, and odors, which are released during various industrial processes.

According to an aspect, the invention offers an innovative solution that overcomes the challenges associated to industrial gas emission and odors by introducing a method of capturing and eliminating industrial gas emissions and odors that is both more efficient and more environmentally friendly. This method is based on a combination of advanced technologies that maximize the elimination of pollutants, while minimizing energy consumption and associated costs. In addition, the invention is designed to be adaptable to a wide range of industrial processes, thus allowing flexible implementation in various industrial applications.

According to an aspect, the invention relates to an advanced membrane oxidation process that combines high-performance ceramic materials with LNS, an electromagnetic radiation oxidation system and/or a hydrogen peroxide oxidation or metal peroxide system. This innovative approach efficiently captures and transforms industrial toxic pollutants such as methane (CH₄), carbon dioxide (CO₂), carbon monoxide (CO), volatile organic compounds (VOCs), acetone, propylene oxide, acetone, benzene-toluene-xylenes (BTX), polycyclic aromatic hydrocarbons (PAHs), chlorofluorocarbons (CFCs), hydrofluorocarbons (HFCs), carbonyl compounds (formaldehyde, acetaldehyde), hydrogen sulfide (H₂S) and ammonia (NH₃), along with acidic emissions like sulfur dioxide (SO₂), nitrogen oxides (NOₓ), hydrogen chloride (HCl), and hydrogen fluoride (HF). Other pollutants, such as fine particles containing arsenic, lead, and cadmium, can also be captured by this invention.

According to an aspect, the process according to the invention addresses the issue of industrial pollution by providing a significantly more efficient solution compared to traditional methods such as activated carbon filters or thermal and catalytic oxidation.

Acid emissions, such as SO₂, NOₓ, HCl, and HF are mainly generated during the combustion of fuels containing sulfur and nitrogen, especially in power plants, cement plants, refineries, and metallurgical industries, chemical industries such as phosphoric acid production, etc. SO₂ comes from the combustion of coal or oil, NOₓ is produced during the high-temperature combustion of these fuels, where nitrogen in the air reacts with oxygen, while HCl and HF come mainly from the combustion of chlorine-containing materials, chemical industrial processes, and incinerators. These emissions, once released into the atmosphere, contribute to air pollution, acid rain, and the creation of ground-level ozone, thus aggravating environmental and health impacts.

Due to the increasing pressure on environmental regulations for installations emitting such toxic emissions, odor (VOCs, H₂S, and NH₃) treatment processes and acid gas flows are increasing. Conventional treatments are often limited by their high energy requirements, maintenance costs, and inability to treat several types of pollutants simultaneity. In addition, these systems may produce hazardous by-products or require additional effluent management steps. On the other hand, lime neutralization for acid emissions, whether dry or semi-humid, generates a significant amount of solid waste, composed for the most part of gypsum polluted by metals considered toxic, such as lead, cadmium, aluminum, arsenic, and others.

The volatile organic compounds may be selected from: ethane, propane, pentane, butane, isopentane, hexane, and tert-butyl cyclohexane; ethylene, propylene, and 1-decene; arenas, in particular benzene, toluene, xylene, ethylbenzene, styrene, and anethol; aldehydes, especially formaldehyde, and acetaldehyde; ketones, especially methyl ethyl ketone and methylisobutylketone; esters, in particular methyl acetate, ethyl acetate, propyl acetate, and butyl acetate; chlorinated volatile organic compounds, in particular dichloromethane, trichloromethane, tetrachloromethane, trichloroethylene, tetrachloroethylene and vinyl chloride; volatile organic sulfur compounds, in particular mercaptans and alkyl sulfides, more particularly dimethyl sulfide, dimethyl disulfide, and diethyl sulfide; and their mixtures.

The acidic pollutants and odor polluants may be selected from: SOₓ, NOₓ, H₂S, SO₂, SO₃, NO, NO₂, N₂O, HF, HCl, mercaptans and their mixtures. Mercaptans may include methanethiol (CH₃SH), ethanethiol (C₂H₅SH), butanethiol (C₄H₉SH), thiophenol (C₆H₅SH), cyclohexanethiol (C₆H₁₁SH).

The fine particles may include arsenic, lead, cadmium, nickel, mercury, and their mixtures.

According to the invention, the inorganic material used for the manufacture of the ceramic membrane can be selected from the following: alumina (Al₂O₃), magnesium oxide (MgO), calcium oxide (CaO), zirconium oxide (ZrO₂), titanium oxide (TiO₂), silicon carbide (SiC), and their mixtures.

According to the invention, the inorganic material used for the manufacture of the liquid nano-sorbent (LNS) can be selected from the following: magnesium oxide (MgO), calcium oxide (CaO), carbon/activated carbon/biochar, dolomites (CaMg(CO₃)₂), fly ashes and their mixtures or their chemical forms.

According to the invention, electromagnetic radiation can be selected from the following: UVA, UVB, and UVC.

Various aspects of the invention are described in detail below. As will be understood by a skilled person the invention is not necessarily limited in its application to the details set out or illustrated by the examples. The invention may have other aspects or be put into practice or carried out in various ways.

The advanced membrane oxidation process according to the invention uses flat porous ceramic membranes to control the nano-liquid circulation and oxidation reactions in the presence of reactive compounds such as ozone (O₃), hydrogen peroxide (H₂O₂), and CaO₂, MgO₂. These membranes, consisting of synthetic ceramic materials, achieve great elimination efficiency while increasing the destruction and capture of VOCs, odors, and acid gases. The invention can use also tubular ceramic membranes for the same reactions.

The process according to the invention integrates a series of advanced treatment steps designed to efficiently treat industrial gas emissions by reducing harmful pollutants to environmentally safe by-products. The process begins with a gas pre-filtration stage aimed at removing suspended solid particles and other impurities that could compromise the efficiency of subsequent steps. This pre-filtration step ensures that the gas stream entering the main treatment units is free from particulate matter, optimizing the overall performance of the process.

Following pre-filtration, the gas stream is directed to a contact step with specialized oxidizing membranes, which are at the core of the invention. These membranes, designed with a controlled porosity, promote optimal contact between the LNS, the oxidizing agent, the electromagnetic radiation and the pollutants, all of which are encountered on the outer surface of the membrane, thus facilitating oxidative reactions and the capture of pollutants. During this stage, toxic contaminants are subjected to chemical reactions that decompose certain compounds while trapping others. Acidic gases, such as hydrogen sulfide (H₂S), are converted to sulphates (SO₄²⁻) and water (H₂O), while sulphur oxides (SOₓ) are converted to sulphates (SO₄²⁻) and nitrogen oxides (NOₓ) are converted to nitrates (NO³⁻). These sulfates and nitrates are then neutralized by calcium and magnesium nanoparticles. These conversion processes are highly efficient and result in stable by-products that are either non-toxic or can be easily separated.

One of the key innovative aspects of the process according to the invention is the ability of the membranes to operate at relatively low temperatures and pressures, thus reducing the system's energy requirements and the overall cost of treatment.

Another important aspect of the invention is its remarkable adaptability to various industrial configurations, making it a versatile solution for a wide range of gas treatment needs. The system is designed with a modular and compact architecture, allowing it to be seamlessly integrated into existing industrial installations without requiring significant modifications to the infrastructure. This flexibility minimizes downtime during installation and reduces the overall cost of implementation, making it an attractive option for industries aiming to upgrade their emission control systems.

The system can be installed as a standalone replacement for traditional gas treatment technologies, such as wet scrubbers, adsorption filters, or catalytic converters, which often have higher operational costs, lower efficiency, or more complex maintenance requirements.

One of the key advantages of the invention is its ability to achieve high pollutant removal efficiency. Experimental results have demonstrated that, under optimal operating conditions, the system can achieve up to 88% reduction in volatile organic compounds (VOCs) and complete reduction of acidic gases such as sulfur oxides (SOₓ), nitrogen oxides (NOₓ), and hydrogen sulfide (H₂S). These results highlight the system's superior performance compared to conventional treatment methods, providing industries with a more efficient and environmentally friendly alternative for reducing harmful emissions.

In addition, the process can also be adjusted to address other contaminants found in industrial emissions, such as heavy metals or ultrafine particles, thus expanding its scope to industrial sectors where air pollution is a critical issue.

This innovative technology thus offers a complete and sustainable solution for the treatment of industrial emissions, meeting increasingly stringent regulatory requirements regarding air quality and contributing to environmental protection and public health.

### Reaction Mechanism of the Invention

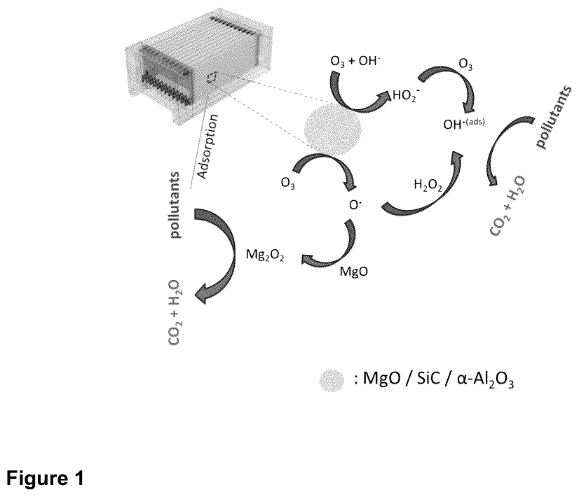

FIG. 1 illustrates the reaction mechanism involved in the advanced membrane oxidation process within the associated system. The reaction mechanism is based on the use of an innovative membrane reactor, designed to optimize the interactions between gaseous contaminants, nano-sorbents, and oxidizing agents generated in situ.

The reactor is equipped with porous ceramic membranes, made from advanced materials such as magnesium oxide (MgO), silicon carbide (SiC), and alumina (Al₂O₃). These membranes play a central role in the process by serving as a reaction surface, bed distributor for the nano-sorbents and as a catalyst. A fluid containing hydrogen peroxide (H₂O₂), magnesium peroxide (MgO₂), calcium peroxide (CaO₂), and the carbon nano-sorbents circulates inside the membranes, providing the necessary oxidizing agents to degrade and capture the pollutants.

The controlled porosity of the membranes allows H₂O₂ to diffuse to the outer surface of the membranes, where the key reaction takes place. On the surface of these membranes, a layer of MgO plays a significant catalytic role. When the layer comes into contact with H₂O₂, MgO reacts to form a specific oxidant, magnesium peroxide (Mg₂O₂), as well as hydroxides (OH^{.}).

Thus, the system generates five powerful oxidizing agents simultaneously, namely, hydrogen peroxide (H₂O₂), magnesium peroxide (MgO₂), calcium peroxide (CaO₂), ozone (O₃), and hydroxides (OH³¹ ).

These oxidants work in synergy to efficiently remove contaminants present in the gas stream. When the gas stream containing pollutants comes into contact with the membrane surface, the five oxidants engage in a competitive oxidation process to transform the contaminants into less harmful by-products, such as carbon dioxide (CO₂), water (H₂O), sulfates (so₄²⁻), and nitrates (no₃³¹).

Thus, the system also generates highly effective nano-sorbents of the activated carbon capable of capturing carbon dioxide, methane, and other pollutants.

Accordingly, the advanced membrane oxidation process relies on the following key reactions:
Magnesium peroxide (MgO₂) acts as an oxidant capable of breaking chemical

bonds in volatile organic compounds and neutralizing acidic gases such as H₂S, SOₓ, and NOₓ.
Calcium peroxide (CaO₂) acts as an oxidant capable of breaking chemical bonds in volatile organic compounds and neutralizing the acidic gases such as H₂S, SOₓ, and NOₓ.
Hydroxides (OH⁻) complement the process by increasing the reactivity of the membrane surface, facilitating the degradation of hard-to-oxidize contaminants.
Hydrogen peroxide (H₂O₂), as a liquid oxidant, penetrates the microchannels of the membrane and contributes to the decomposition of refractory pollutants.
Carbon nano-sorbents capable of capturing carbon dioxide, methane, and other pollutants.

This advanced oxidation mechanism is particularly effective in removing a wide range of gaseous pollutants, including sulfur compounds, nitrogen oxides, volatile organic compounds, and other acidic and toxic gases.

### Description of the Pilot Unit Used for the Invention

A functional pilot unit was designed, manufactured, and commissioned for real operational conditions testing in an industrial facility treating wastewater and producing biogas.

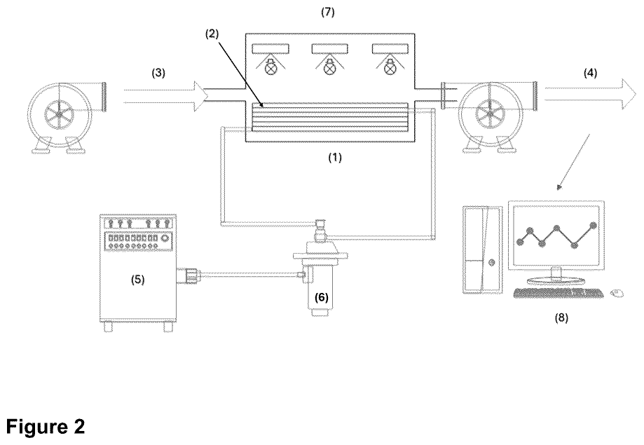

FIG. 2 represents a schematic diagram of the process according to the invention for treating acid gas effluents, VOC, and odors. This illustration does not include all the components necessary for the implementation of the process, e.g., heat exchangers, pumps, mixers, etc. Only the elements necessary for the understanding of the invention are represented. The skilled person is able to complete this representation in order to implement the invention. More specifically, Figure outlines the following elements of the process and associated system: membrane reactor (1), porous ceramic membrane (2), gas flow input (3), gas flow output (4), ozone generator (5), liquid nano-sorbent distributor (6), UV system (7), analysis system (8).

The advanced membrane oxidation process described herein is composed of four key components that work together to achieve efficient pollutant removal: the membrane reactor, an ozone generator, an LNS distributor and a UV system. Each of these components plays a critical role in generating and activating oxidants to degrade harmful compounds in gas streams. Below are a detailed breakdown of each component and its function within the process.

### Membrane Reactor

The core of the system is the membrane reactor, which contains porous ceramic membranes made from advanced materials such as magnesium oxide (MgO), silicon carbide (SiC), and alumina (Al₂O₃). These membranes serve multiple purposes, including:
Encounter point: designed with a controlled porosity, promote optimal contact between the nano-sorbent, the oxidizing agent, the electromagnetic radiation and the pollutants, all of which are encountered on the outer surface of the membrane, thus facilitating oxidative reactions and the capture of pollutants.
Filtration and separation: The membranes act as a physical barrier, removing solid particles and facilitating the selective permeation of fluids.
Catalytic surface: The surface of the membranes contains a layer of MgO, which interacts with oxidizing agents such as hydrogen peroxide (H₂O₂) to form reactive compounds like magnesium peroxide (MgO₂) and hydroxides (OH⁻). These reactive species enhance the oxidation process and degrade contaminants.

The membrane reactor is a closed-loop system, ensuring that all gas emissions pass through the oxidation stages, reducing the risk of untreated emissions.

### Ozone Generator

The system includes an ozone generator, which plays a vital role in producing ozone (O₃)—a powerful oxidant that enhances the degradation of pollutants in the gas stream. The ozone generator works as follows:
Ozone production: the generator converts oxygen into ozone through a process called corona discharge.
Oxidation boost: The ozone produced goes directly into the LNS distributor, where it generates oxidizing agents such as H₂O₂, CaO₂, MgO₂, and OH⁻, further increasing the oxidation efficiency. These agents are then sent to the membranes surface to interact with the pollutants.

The controlled dosing of ozone ensures that the system operates efficiently without producing excessive ozone, which could pose safety or environmental risks.

### UV System (180-250 Nm)

The UV system emits ultraviolet light in the 180-250 nm wavelength range. This specific UV range is chosen for its ability to produce hydroxyl radicals (OH·) and activate ozone, further enhancing the oxidation process. The UV system operates as follows:
Photolysis of H₂O₂: UV light at this wavelength breaks down hydrogen peroxide (H₂O₂) into highly reactive hydroxyl radicals (OH·), which are among the most powerful oxidants known for degrading pollutants.
Activation of ozone: UV light also helps decompose ozone into additional oxygen radicals, further boosting the oxidation process.

The UV system's wavelength is suitably selected such as to balance high energy for effective oxidation with minimal by-product formation, ensuring a safe and efficient process.

### Liquid Nano-Sorbent (LNS) Preparation

The state of the art concerning nanoparticles manufacturing methods highlights two main approaches. The first, known as bottom-up, is the most widely used and relies on synthesis from molecular precursors, such as metal salts. The second approach, called top-down, involves breaking down bulk materials. Although this method is less common, it is economically more cost-effective. However, its application remains limited to specific materials, such as silicon or silver.

US 2011-0070443A1 describes the use of precursors (metal salts such as Cd(CH₃CO₂)₂ or AgNO₃, and chalcogen sources like TOPSe) dissolved in high-boiling-point solvents (e.g., hexadecylamine, TOPO). The process involves gradual heating (120-280° C.) to induce nucleation and growth, while organic ligands act as capping agents to stabilize the nanoparticles and control their size (ranging from 2 to 100 nm).

Other studies have explored solid-phase synthesis, where silver salts are mixed with water-soluble polymers (e.g., PVP) followed by a solvent-free chemical reduction; see for example US 2012-0225126.

Another study, US 6,585,947 B1, employed a top-down approach based on electrochemical etching of a silicon wafer in an HF/H₂O₂ acid bath, with an applied current to produce nanoparticles (~1 nm). This was followed by ultrasonic separation and coarse filtration (e.g., 200 nm filter).

These methods are mechanically simpler but less common for achieving well-controlled nanoparticle sizes and uniform dispersion, as they focus on physical decomposition rather than chemical synthesis.

The nanoparticle preparation method described in this invention relies on an advanced top-down approach, followed by a specific membrane nanofiltration step. It differs from prior art through the integration of targeted nanofiltration as a purification and size-control stage after grinding.

The use of dispersing and stabilizing agents enables precise particle size selection with a yield exceeding 70%, which facilitates separation during nanofiltration step. This combination makes our approach potentially more scalable and environmentally friendly by avoiding toxic solvents and complex chemical reactions typical of dominant bottom-up methods, while ensuring fine control over monodispersity through membrane nanofiltration.

The present description relates to a method for preparing nanoparticles, within the size range 20-100 nm, constituting LNS from at least one material or their mixtures selected from MgO, CaO, ZnO, carbon/activated carbon/biochar, dolomites (CaMg(CO₃)₂), fly ashes, or their mixtures.

The raw materials are first subjected to ultrafine mechanical grinding to achieve a particle size reduction in the range of 20-50 μm, followed by mechanical sieving to obtain a fraction of particles of uniform micrometric size, less than 30 μm. Then, the following steps are conducted:
a. The sieved particles are dispersed in deionized water or an aqueous mixture to form a suspension. The aqueous mixture contains a dispersing agent, such as an anionic surfactant (e.g., sodium dodecyl sulfate), and/or at least one stabilizing polymer (e.g., sodium polyacrylate), at a concentration between 0.1% and 3% by weight.
b. Agitating constantly to enhance dispersion, promoting a homogeneous suspension of nano and micrometric particles. The mixture is then subjected to mechanical grinding at a speed ranging from 200 to 1000 rpm, and/or by ultrasonication at a frequency ranging from 30 to 50 kHz for a duration ranging from 60 minutes to 180 minutes, at room or slightly elevated temperature ranging from 22° C. to 40° C.

Further, the resulting suspension is subjected to a nanofiltration process as follows:
a. Filtrating the resulting suspension using a nanofiltration membrane technology with a pore size ranging from 20 nm to 100 nm, and a filtration pressure ranging from 4 to 10 bar.
b. Nanofiltration is carried out in tangential flow mode or in dead-end mode to separate nanoparticles from larger aggregates. The process allows the recovery of a permeate comprising nanoparticles having a characteristic size smaller than 100 nm, while a retentate comprising larger species may be recycled or removed. In an embodiment, the nanofiltration step is performed under controlled temperature conditions (ranging from 22° C. to 40° C.) suitable for preserving the integrity of the nanoparticles.

Another embodiment of this invention provides a process for the nanofiltering the resulting suspension, which comprises the following steps:
a. Concentrating the permeate by nanofiltration process.
b. Redispersing the permeate in a stable suspension medium, such as an aqueous solution containing a stabilizer at a pH adjusted between 8 and 12.
c. Homogenizing the suspension by agitation or ultrasonication for 30 to 90 minutes to ensure colloidal stability, thus avoiding the agglomeration of nanoparticles.

The method according to the invention makes it possible to obtain sorbents nanoparticles of high purity, having a narrow particle size distribution, typically with an equivalent diameter of less than 100 nm.

### Testing Conditions: Analysis of the Gas Mixture (Carried Out in a Full-Scale Industrial Wastewater Treatment and Biogas Production Facility)

Prior to the introduction of sludge into the digester for biogas production, odorous gas emissions were observed during the storage phase. In this context, the inventor carried out an analysis of the gas composition emitted from sludge storage. The tests were carried out in a full-scale industrial wastewater treatment and biogas production facility. The initial testing conditions were representative of normal operating conditions. An average temperature of 14.2° C. A relative humidity of 87%. The airflow rate in the plant's main duct was 1000 CFM (cubic feet per minute). The flow rate measured in the prototype duct reached 96.4 CFM. The mass percentage of nanoparticles in the LNS solution has been maintained between 5% and 15%.

The inventor conducted a detailed analysis of the gas composition emitted during sludge storage. The average concentrations of the main components are summarized as follows:
Methane (CH₄): The measured concentration was 9.8%, compared to the typical biogas range of 50-70%, indicating the beginning of the methanogenesis phase.
Oxygen (O₂): the measured value was 17.5%.
Carbon dioxide (CO₂): The concentration reached 21.5%, which is consistent with the initial stage of fermentation, although lower than the normal biogas range (30-50%).
Hydrogen (H₂): The measured value was 11.4 ppm, remaining within the normal range (<100 ppm) typically observed during the acetogenic phase.
Hydrogen sulfide (H₂S): A concentration of 5.3 ppm was detected.
Sulfur dioxide (SO₂): A concentration of 4.7 ppm was detected.
Ammonia (NH₃): The level measured was 11 ppm.
Nitric oxide (NO): The concentration was 5.1 ppm.
Nitrogen dioxide (NO₂): The concentration was 0 ppm, matching the biogas standard (0 ppm).
Volatile organic compounds (VOCS): The total concentration was 14.7 ppm.

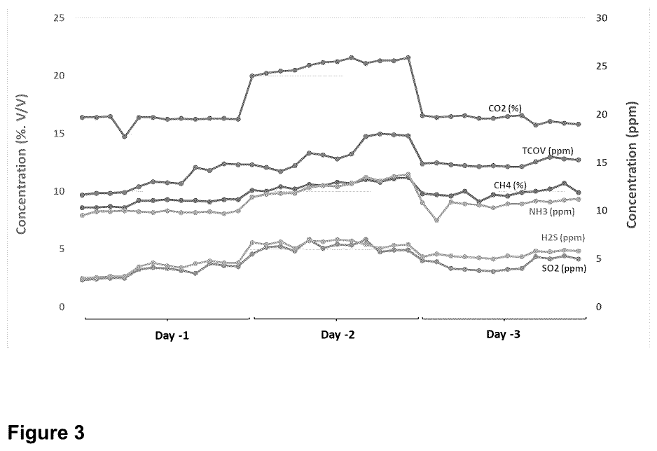

The inventor analyzed the stability of gaseous emissions in order to observe variations in composition over time. FIG. 3 illustrates a stable behavior of the gas concentrations throughout the monitoring period, with a slight increase observed on the second day, possibly related to the loading process of the system during the analysis.

The stability of the analyses of raw gas emissions over time is as follows:
Carbon dioxide: The initial CO₂ concentration remained stable around 16-17%. A temporary increase was observed on Day 2, reaching approximately 21-22%, followed by a rapid return to the initial level on Day 3. This transient peak is likely associated with enhanced fermentation activity or variations in aeration and temperature. The rapid recovery to baseline levels indicates good system resilience.
Total volatile organic compounds (TVOC): The TCOV concentration gradually increased from Day 1 (approximately 9 ppm) to Day 2 (approximately 18 ppm), before stabilizing around 16 ppm on Day 3. This evolution reflects the progressive biological degradation or the gradual release of volatile odorous compounds. The stabilization observed at the end of the monitoring period is considered a positive indicator of process equilibrium.
Ammonia (NH₃): The evolution pattern of NH₃ was similar to that of methane (CH₄), showing peaks on Day 2 (around 12 ppm) followed by a return to the initial level of approximately 10 ppm. These fluctuations are linked to variations in temperature or pH, influencing the release of ammonia from nitrogenous compounds.
Sulfur dioxide and hydrogen sulfide exhibited the same temporal pattern, with average concentrations of 4.7 ppm and 5.3 ppm, respectively. The rapid return to the initial values demonstrates good overall system stability.

The analyzed gases (including H₂S, SO₂, NH₃, CH₄, and total VOCs) are major contributors to the observed gas emissions. However, they represent only part of the gaseous compounds typically found in this type of emission stream. Other volatile molecules, not directly analyzed but likely present, include:
Mercaptans (thiols) such as methylmercaptan and ethylmercaptan, associated with rotten cabbage or sulfurous odors typically perceived as rotten egg smell.
Volatile fatty acids, including butyric and propionic acids, responsible for cheese-like or sweaty odors.
Volatile amines, such as trimethylamine, producing a rotten fish odor.
Aldehydes, including acetaldehyde and formaldehyde, associated with fermented or pungent notes.
Phenolic and indolic compounds, such as phenol, skatole, and indole, producing fecal or animal-like odors.
Organic sulfur compounds, including dimethyl sulfide and dimethyl disulfide, giving rise to garlic-, cabbage-, or sewer-like odors.

### Gas Emissions Treatment by the AMOP Process

The inventor investigated the effect of the air flow rate on the conversion of odorous compounds using the advanced membrane oxidation process (AMOP) pilot unit. Tests were conducted at different flow rates ranging from 10 to 96 CFM.

The results showed that CH4 conversion was complete at low flow rate (10 CFM), reaching 100% conversion, but progressively decreased as the flow rate increased, reaching approximately 43% at 96 CFM. NH3 maintained at 99% conversion on all flow rate (up to 96 CFM), while H₂S and SO₂ also remained efficiently treated with removal efficiencies of 100%. The total concentration of total volatile organic compounds (TVOC) exhibited high conversion (100%) up to 50 CFM, then slightly decreased to 82% at 96 CFM. On the other hand, CO₂ emissions were reduced by 71% at 10 CFM and 55% at 96 CFM.

These results demonstrate that the air flow rate has a significant influence on the overall performance of the system, particularly on the conversion of CH₄. The methane concentration used in the tests was 10% v/v, which is high for our unit pilot capacity, leading to a short gas residence time within the membrane reactor. The same explanation applies to CO₂, which had an average concentration ranging between 19% and 21%. This level is considered relatively high, and it can be attributed to two main factors: 1—the membrane's contact surface lower, and 2—the proportion of nano-sorbent, especially the nano-carbon in the LNS, which was limited to 5%, thereby reducing the overall absorption capacity.

The technology AMOP remains efficient at low and medium flow rates while ensuring effective treatment of H₂S, SO₂, NH₃, and TVOC in these testing conditions.

The inventor investigated, in the laboratory, the effect of the proportion of nano-sorbent in the LNS on the reduction of CO₂ using the advanced membrane oxidation process (AMOP) pilot unit. Tests were conducted at different proportions of nano-sorbent, 5 % and 15 % (v/v). The concentration of CO₂ in the gas stream was set at 20% and the flow rate was set at 96 CFM.

The results obtained in the laboratory confirmed those observed at the plant. A 57% reduction in CO₂ was recorded when the nano-sorbent concentration was 5%, indicating a considerable efficiency even at low levels.

However, when the nano-sorbent proportion reached 15%, a complete removal of CO₂ was achieved, corresponding to a 100% reduction. This clearly demonstrates the impact of increasing the LNS concentration on the overall process performance.

### Discussion and Conclusions

The results of the advanced membrane oxidation process (AMOP) demonstrated its superior efficiency compared to conventional technologies such as adsorption filters, scrubbing, and thermal oxidation. The system's ability to handle high pollutant loads while maintaining high removal efficiency makes it a viable solution for industrial air pollution control.

According to aspects of the invention, key findings include high removal efficiency of up to 100% for acid gases and up to 82% for TVOCs; stable performance across a wide range of pollutant concentrations; and low energy consumption due to the low-pressure operation of the ceramic membranes and optimized UV/ozone integration.

These results validate the innovative approach of combining advanced oxidation processes with ceramic membrane technology, offering a scalable and eco-friendly solution for industrial gas treatment.

The results of the study confirm that the advanced membrane oxidation process offers outstanding pollutant removal performance for both acidic gases and volatile organic compounds. The system demonstrated up to 100% for acidic gases and up to 82% for TVOCs, even at high inlet concentrations, making it a reliable solution for industries that generate significant emissions.

The airflow rate impacts performance, particularly for methane and carbon dioxide. The technology is highly effective at low and medium flow rates.

The prototype unit significantly outperforms activated carbon in the treatment of the selected emissions.

The combination of ceramic membranes, ozone, and UV oxidation effectively reduces the formation of secondary by-products and residual ozone emissions, ensuring that the process is both environmentally friendly and economically sustainable. The modular design of the system enables its easy integration into existing facilities, reducing the need for significant infrastructure upgrades.

One of the significant advantages of this invention is that the process can be executed continuously, with real-time monitoring and adjustments performed while the system is operating. This feature ensures optimal performance, allowing industries to adapt the process to varying pollutant loads and reduce operational costs by minimizing downtime.

In comparison with traditional air pollution control systems, the membrane-based oxidation process provides superior performance, lower energy consumption, and long-term stability, making it a viable and scalable technology to address the growing need for clean industrial air.

Overall, this innovative process contributes significantly to reducing industrial emissions, helping companies meet strict environmental regulations while promoting sustainable practices in air pollution management.

As will be understood by a skilled person, other variations and combinations may be made to the various embodiments of the invention as described herein above.

While the present disclosure has been described in connection with specific embodiments thereof, it will be understood that it is capable of further modifications and this application is intended to cover any variations, uses, or adaptations including such departures from the present disclosure as come within known or customary practice within the art and as may be applied to the essential features hereinbefore set forth, and as follows in the scope of the appended claims. Features which are described in the context of separate aspects and embodiments of the invention may be used together and/or be interchangeable. Similarly, features described in the context of a single embodiment may also be provided separately or in any suitable sub-combination.

The scope of the claims should not be limited by the preferred embodiments set forth herein above; but should be given the broadest interpretation consistent with the description as a whole.

The present description refers to a number of documents, the content of which is herein incorporated by reference in their entirety.

1. A process for treating a gaseous material, comprising contacting the gaseous material with an oxidizing porous ceramic membrane placed within a reactor, wherein an oxidizing agent associated with the membrane is formed upon reaction between a membrane material and ozone (O₃) that is fed into the reactor;
optionally the oxidizing porous ceramic membrane is subjected to an electromagnetic radiation during the process.

2. The process according to claim 1, wherein a liquid comprising a sorbent material flows through the membrane during the process, and formation of the oxidizing agent further involves the sorbent material;
preferably the sorbent material is in nano form; more preferably the liquid is a liquid nano-sorbent (LNS).

3. The process according to claim 1, wherein a fluid comprising hydrogen peroxide (H₂O₂) flows through the membrane during the process, and formation of the oxidizing agent further involves H₂O₂.

4. The process according to claim 2, wherein a fluid comprising hydrogen peroxide (H₂O₂) flows through the membrane during the process, and formation of the oxidizing agent further involves H₂O₂.

5. The process according to claim 1, comprising contacting the gaseous material with the oxidizing porous ceramic membrane placed within a reactor, wherein a liquid comprising a sorbent material and a fluid comprising hydrogen peroxide (H₂O₂) each independently flows through the membrane, and wherein the oxidizing agent associated with the membrane is formed upon reaction between a membrane material, the sorbent material, H₂O₂, and ozone (O₃) that is fed into the reactor.

6. The process according to claim 1, wherein the membrane material is selected from the group consisting of: alumina (Al₂O₃), magnesium oxide (MgO), calcium oxide (CaO), zirconium oxide (ZrO₂), titanium oxide (TiO₂), silicon carbide (SiC), and a combination thereof;
preferably the membrane material is magnesium oxide (MgO).

7. The process according to claim 1, wherein the oxidizing agent is selected from the group consisting of: hydrogen peroxide (H₂O₂), MgO₂, CaO₂, ozone (O₃), and a combination thereof.

8. The process according to claim 1, wherein the sorbent material is selected from the group consisting of: magnesium oxide (MgO), calcium oxide (CaO), carbon/activated carbon/biochar, dolomites (CaMg(CO₃)₂), fly ashes, and a combination thereof;
preferably the sorbent material is selected from the group consisting of: nanoparticles of magnesium hydroxide (Mg(OH)₂), nanoparticles of calcium hydroxide (Ca(OH)₂), nanoparticles of carbon/activated carbon/biochar, nanoparticles of dolomites (CaMg(CO₃)₂), nanoparticles of fly ashes, and a combination thereof.

9. The process according to claim 1, wherein the electromagnetic radiation is an ultraviolet (UV) radiation selected from the group consisting of UVA, UVB, and UVC.

10. The process according to claim 1, wherein the membrane has a shape that is flat or tubular;
preferably the membrane is flat.

11. The process according to claim 1, wherein the membrane has a porosity which is adapted for allowing a liquid containing the oxidizing agent to diffuse throughout the membrane from an inside surface to an outer surface thereof.

12. The process according to claim 1, wherein the membrane operates at a relatively low temperature and/or a relatively low pressure.

13. The process according to claim 1, which is executed continuously and/or which is adapted for real-time monitoring and adjustments.

14. The process according to claim 1, wherein the gaseous material is an industrial gas emission.

15. The process according to claim 1, wherein the gaseous material comprises industrial toxic pollutants such as methane (CH₄), carbon monoxide (CO), carbon dioxide (CO₂) volatile organic compounds (VOCs), propylene oxide, acetone, benzene-toluene-xylenes (BTX), polycyclic aromatic hydrocarbons (PAHs), chlorofluorocarbons (CFCs), hydrofluorocarbons (HFCs), carbonyl compounds (formaldehyde, acetaldehyde), hydrogen sulfide (H₂S) and ammonia (NH₃), along with acidic emissions like sulfur dioxide (SO₂), nitrogen oxides (NOx), hydrogen chloride (HCl), hydrogen fluoride (HF), and fine particles.

16. The process according to claim 1, wherein a content of the treated gaseous material is about 82% to about 99% reduced in volatile organic compounds (VOCs) and acidic gases such as sulfur oxides (SOₓ), nitrogen oxides (NOₓ), and hydrogen sulfide (H₂S).

17. A system for treating a gaseous material, comprising: a reactor; at least one porous ceramic membrane placed into the reactor; and an ozone (O₃) distributor adapted to feeding O₃ into the reactor;
optionally the system comprises a hydrogen peroxide (H₂O₂) distributor adapted to feeding H₂O₂ to the at least one membrane;
optionally the system comprises a liquid sorbent material distributor adapted to feeding the liquid sorbent material to the at least one membrane;
optionally the system comprises an ultraviolet (UV) radiation system adapted to submitting radiation to the at least one membrane;
preferably the O₃ distributor comprises means for controlling an amount of O₃ fed into the reactor;
preferably the O₃ distributor receives O₃ from an ozone (O₃) generator adapted to generate O₃ from oxygen;
preferably the system is a closed-loop system;
preferably the system is adapted for integration into existing industrial installations without requiring significant modifications to the infrastructure.

18. A gas treatment plant comprising a plurality of systems as defined in claim 17;
optionally the systems are mounted in a mode selected from; parallel mode, modular mode, compact mode, standalone mode, and a combination thereof.

19. A method for preparing a liquid nano-sorbent, comprising: a first step based on a top-down approach and a second step based on a membrane nanofiltration technology, optionally, prior to conducting the first and second steps of the method, raw materials are subjected to ultrafine mechanical grinding followed by mechanical sieving to obtain sieved particles;
optionally the first step of the method comprises forming a suspension comprising the sieved particles and a dispersing agent, and subjecting the suspension to mechanical grinding;
optionally the second step of the method comprises subjecting the grinded suspension to a membrane nanofiltration wherein a permeate is recovered, and a retentate with larger size particles is removed or recycled;
optionally the method further comprises subjecting the permeate to a nanofiltration process comprising use of a stabilizer.

20. A liquid nano-sorbent obtained by the method as defined in claim 19, optionally an equivalent diameter of particles of the liquid nano-sorbent is less than 100 nm or is between about 20 to about 100 nm.
